(19) United States
(12) Patent Application Publication
(10) Pub. No.: US 2025/0312132 A1
(43) Pub. Date: Oct. 9, 2025

(54) INTRA-ORAL DENTAL APPLIANCE

(71) Applicant: Xerosguard Inc., Winnipeg (CA)

(72) Inventors: Gord Parke, Winnipeg (CA); Robert Ward, Calgary (CA)

(21) Appl. No.: 18/866,190

(22) PCT Filed: May 17, 2023
(86) PCT No.: PCT/CA2023/050676

§ 371 Date: Nov. 15, 2024

Related U.S. Application Data
(60) Provisional application No. 63/342,669, filed on May 17, 2022.

(51) Int. Cl. A61C 17/10; A61C 17/06

(52) U.S. Cl. CPC A61C 17/10; A61C 17/096

(57) ABSTRACT

An intra-oral dental appliance is provided. The intra-oral appliance can have an external member, flexible and poseable first and second suction arms having tubing and a connector connected to the first and second suction arms, the connector connectable to a vacuum source. The first and second suction arms positionabe independently from one 5 another and connectable to the external member. The external member can have first and second apertures sized to accept tubing to hold the tubing in place.

The present invention relates to dental appliance and more particularly an intra-oral appliance for providing moisture control.

### BACKGROUND

Moisture control is the removal of excess saliva and other fluids, along with debris such as removed plague, etc., from a patient's mouth during a dental procedure, such as teeth cleaning or other some other procedure. There are a number of methods and techniques that are used to try and control the moisture in a patient's mouth, however, there are challenges. The inside of a patient's mouth is only so large, so there is limited room inside the patient's mouth. In addition, the moisture control is typically done in conjunction with a dental procedure so the moisture control system must not impede or at least limit the impediment to the dental procedures. Additionally, the fluid can pool in various places depending on a patient's position, mouth size, etc. These all present challenges for moisture control.

The more recent popularity of ultrasonic scalers for dental hygienists has increased the need for moisture control in cleaning procedures performed by dental hygienists. An ultrasonic scaler uses ultrasound to remove calculus deposits and clean teeth. It creates ultrasonic waves which blast biofilm, plaque and calculus from a patient's teeth. This removed material is flushed away from the patient's teeth by continuous jet of water emitted from the ultrasonic scaler. The vibrating of the ultrasonic scaler will also create bubbles in this emitted water which can aid in the cleaning of the patient's teeth by cavitation. However, this water is continuously injected into the patient's mouth during the use of the ultrasonic scaler and must be continuously removed to prevent the patient from swallowing or aspirating this water, making moisture removal even more important than with the traditional manual descaling of a patient's teeth.

### SUMMARY OF THE INVENTION

In an aspect, an intra-oral dental appliance is provided. The intra-oral appliance can have an external member, a flexible and poseable first suction arm comprising: a first end; a second end, hollow tubing; and a suction tip provided at the second end of the first suction arm, a flexible and poseable second suction arm comprising: a first end; a second end; hollow tubing; and a suction tip provided at the second end of the second suction arm, and a connector connected to the first end of the first suction arm and the first end of the second suction arm, the connector connectable to a vacuum source. The second end of the first suction arm is positionable independently from the second end of the second suction arm. The first suction arm and the second suction arm connectable to the external member.

In another aspect, an external member for keeping a patient's mouth open is provided. The external member can include a first lip retractor having a generally arcuate shape with an inner surface and an outer surface having an open channel with a substantially semi-circular cross-section, a second lip retractor having a generally arcuate shape with an inner surface and an outer surface having an open channel with a substantially semi-circular cross-section, a first retractor flange having a front end connected to the first lip retractor and extending outwards from the other surface of the first lip retractor, a second retractor flange having a front end connected to the second lip retractor and extending outwards from the other surface of the second lip retractor, a first wing member attached to the first lip retractor and extending backwards from the inner surface of the first lip retractor, a second wing member attached to the second lip retractor and extending backwards from the inner surface of the second lip retractor, and a flexible resilient member connected between the first retractor flange and the second retractor flange, the flexible resilient member biasing the first lip retractor and the second lip retractor apart. The external member can also include a first aperture sized to accept tubing and passing through the first retractor flange, a first opening at a top of the first retractor flange and leading into the first aperture, a second aperture sized to accept tubing and passing through the second retractor flange, a second opening at a top of the first retractor flange and leading into the second aperture, a first channel provided in the first wing member and aligned with the first aperture, the first channel having an outer wall and an inner wall, the outer wall of the first channel extending further than the inner wall of the first channel, and a second channel provided in the second wing member and aligned with the second aperture, the second channel having an outer wall and an inner wall, the outer wall of the second channel extending further than the inner wall of the second channel.

In another aspect, an external member for keeping a patient's mouth open is provided. The external member can include a first lip retractor having a generally arcuate shape with an inner surface and an outer surface having an open channel with a substantially semi-circular cross-section, a second lip retractor having a generally arcuate shape with an inner surface and an outer surface having an open channel with a substantially semi-circular cross-section, a first retractor flange having a front end connected to the first lip retractor and extending outwards from the other surface of the first lip retractor, a second retractor flange having a front end connected to the second lip retractor and extending outwards from the other surface of the second lip retractor, a first wing member attached to the first lip retractor and extending backwards from the inner surface of the first lip retractor, a second wing member attached to the second lip retractor and extending backwards from the inner surface of the second lip retractor, and a flexible resilient member connected between the first retractor flange and the second retractor flange, the flexible resilient member biasing the first lip retractor and the second lip retractor apart. The external member can also include a first aperture sized to accept tubing and passing through at least one of: the first lip retractor; and, the first retractor flange, a first opening in the inner surface of the of the first lip retractor sized to allow tubing to pass through the first opening, the first opening leading into the first aperture, a second aperture sized to accept tubing and passing through at least one of: the second lip retractor; and, the second retractor flange, and a second opening in the inner surface of the of the second lip retractor sized to allow tubing to pass through the second opening, the second opening leading into the second aperture.

### DESCRIPTION OF THE DRAWINGS

A preferred embodiment of the present invention is described below with reference to the accompanying drawings, in which:

FIG. 1 is a perspective view of a dental appliance;

FIG. 2 is a perspective front-top view of the dental appliance shown in FIG. 1;

FIG. 3 is a perspective back-top view of the dental appliance shown in FIG. 1;

FIG. 4 is a schematic view of a first suction arm and a second suction arm;

FIG. 5 is a perspective view of an external member;

FIG. 6 is a perspective front-top view of the external member shown in FIG. 5;

FIG. 7 is a perspective back-top view of the external member shown in FIG. 6;

FIG. 8 is a perspective view of an external member in another aspect;

FIG. 9 is a front view of the external member shown in FIG. 8;

FIG. 10 is a top view of the external member shown in FIG. 8;

FIG. 11 is a perspective view of a lip retractor in a further aspect; and

FIG. 12 is a front view of the lip retractor shown in FIG. 11.

### DETAILED DESCRIPTION OF THE ILLUSTRATED EMBODIMENTS

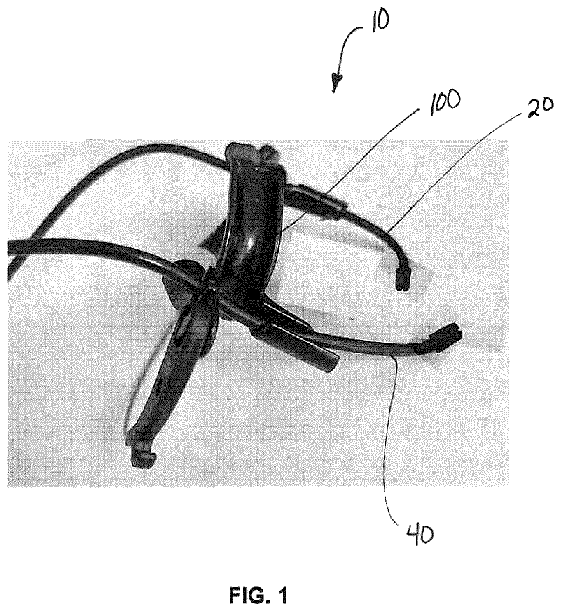

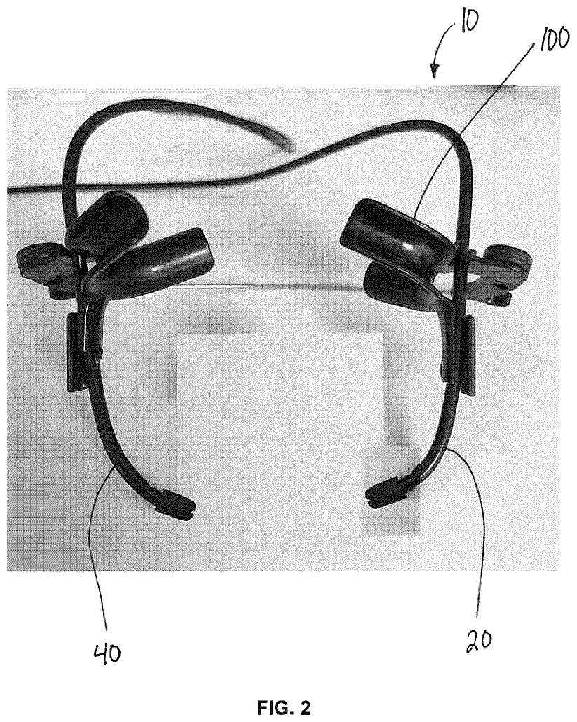

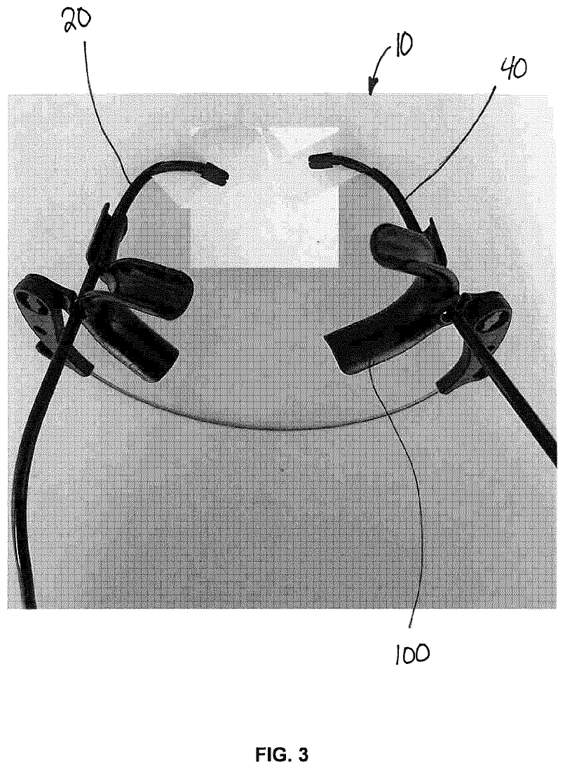

Referring to FIGS. 1-3, an intra-oral dental appliance 10 is shown having an external member 100, a first suction arm 20, and a second suction arm 40 for fluid/moisture control. The dental appliance 10 can be used to create and maintain a dry field in the patient's mouth by removing fluid and debris from the patient's mouth. The external member 100 is used to retract the lips of the patient and hold the patient's mouth open. The first suction arm 20, and second suction arm 40 are used to remove fluid and debris from the patient's mount.

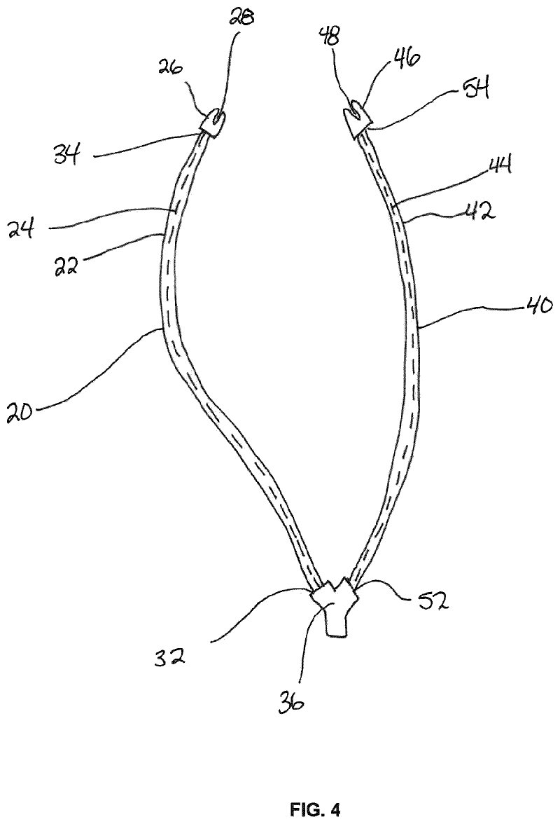

Referring to FIG. 4, the first suction arm 20 can including hollow tubing 22, a poseable wire 24 integrated into the tubing 22, and a suction tip 26 and the second suction arm 40 can include hollow tubing 42, a poseable wire 44 integrated into the tubing 42, and a suction tip 46.

The first suction arm 20 and the second suction arm 40 can have sufficient length so that the first suction arm 20 and the second suction arm 40 extend out of the mouth of a patient, past the patient's lips, when the first suction arm 20 and the second suction arm 40 are connected to the external member 100.

The first suction arm 20 can extend from the first end 32 to a second end 34 and the second suction arm 40 can extend from the first end 52 to the second end 54. Both the first suction arm 20 and the second suction arm 40 can be flexible and poseable so that a user can bend the suction arms 20, 40 into a desired position and the suction arms 20, 40 will maintain this position. The first suction arm 20 and the second arm 40 can undergo intentional plastic deformation and then hold the new shape until moved again.

The second end 34 of the first suction arm 20 is unconnected with the second end 54 of the second suction arm 40 so that the second end 34 of the first suction arm 20 is positionable independently from the second end 54 of the second suction arm 40 and vice versa. In this manner, the user can position the first end 34 of the first suction 20 where they desire in the patient's mouth and then the second end 54 of the second suction arm 40 can be positioned somewhere else in the patient's mouth without affecting the position of the second end 34 of the first suction arm 20.

The first end 32 of the first suction arm 20 can be connected to a connector 36 for connecting to a vacuum source to create a vacuum in the tubing 22 in the first suction arm 20 and therefore create suction in the first suction arm 20. The suction tip 26 can be provided at the second end 34 of the first suction arm 20 to close off an open end of the first suction arm 20. The suction tip 26 can have one or more small apertures 28 provided in it that have less cross-sectional area than the tubing 22 to increase the air flow through the suction tip 26 and into the first suction arm 20 when a vacuum is created in the tubing 22.

The first end 52 of the second suction arm 40 can also be connected to the connector 46 for connecting to a vacuum source to create a vacuum in the tubing 42 in the second suction arm 40 and therefore create suction in the second suction arm 40. The suction tip 46 can be provided at the second end 54 of the first suction arm 20 to close off an open end of the first suction arm 20. The suction tip 46 can have one or more small apertures 58 provided in it that have less cross-sectional area than the tubing 42 to increase the air flow through the suction tip 46 and into the first suction arm 20 when a vacuum is created in the tubing 42.

The poseability of the first suction arm 20 and the second suction arm 40 allow a user to position the second ends 34, 54 of the first and second suction arms 20, 40, with the suction tips 26, 46, in a desired location in a patient's mouth so that the suction created by the suction arms 20, 40 can remove fluid and debris from the patient's mouth.

The first suction arm 20 and the second suction arm 40 can also allow maximum intercuspation of a patient's teeth. The first suction arm 20 and the second suction arm 40 can be routed behind a patient's molars and pass over his or her retro-molar pad. By being able to position the suction arms 20, 40 where desired and over the patient's retro-molar pad behind the dental arches, the suction arms 20, 40 will not pass between the patient's upper and lower teeth, allowing the patient to close their upper and lower teeth together (bite) while the suction arm 20, 40 provide moisture control.

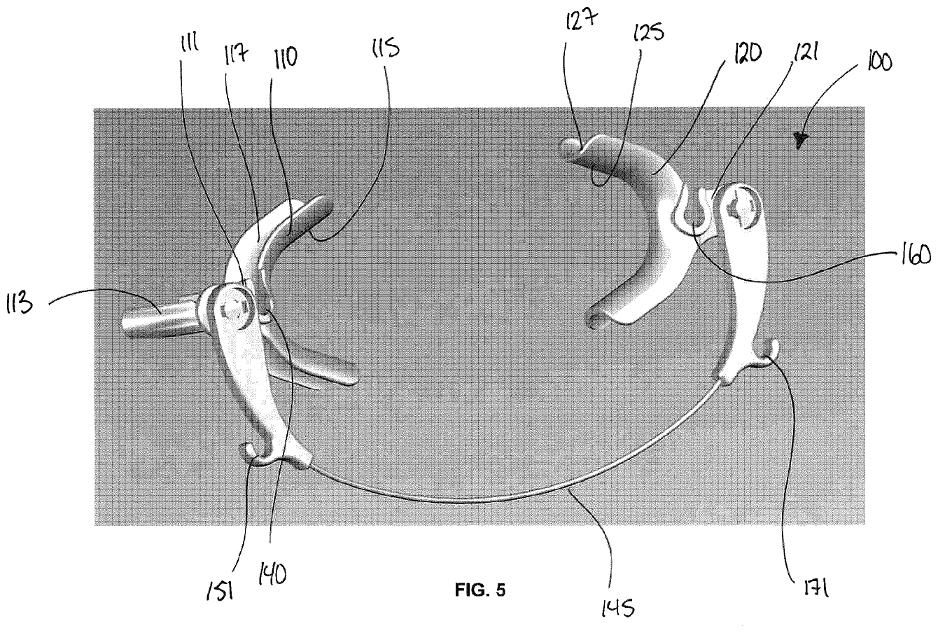

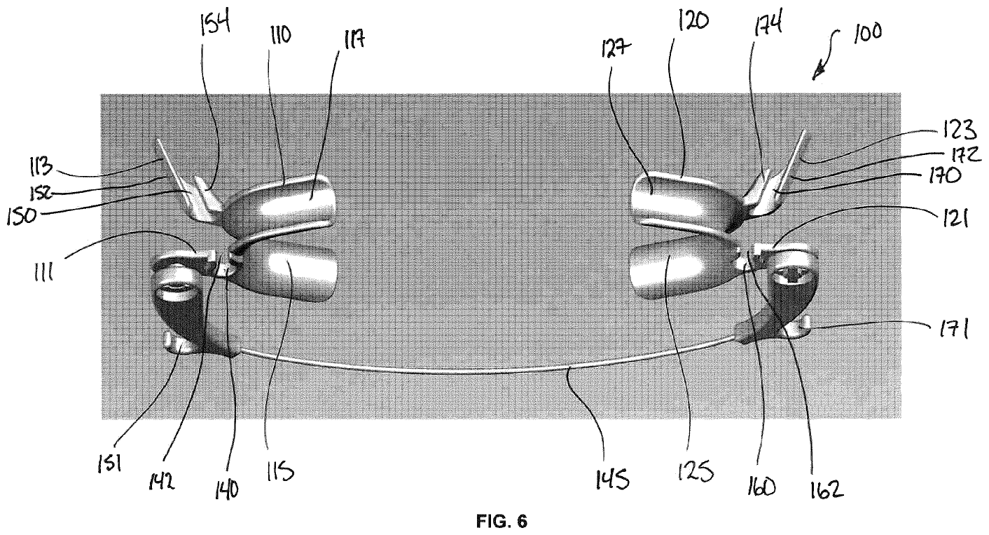

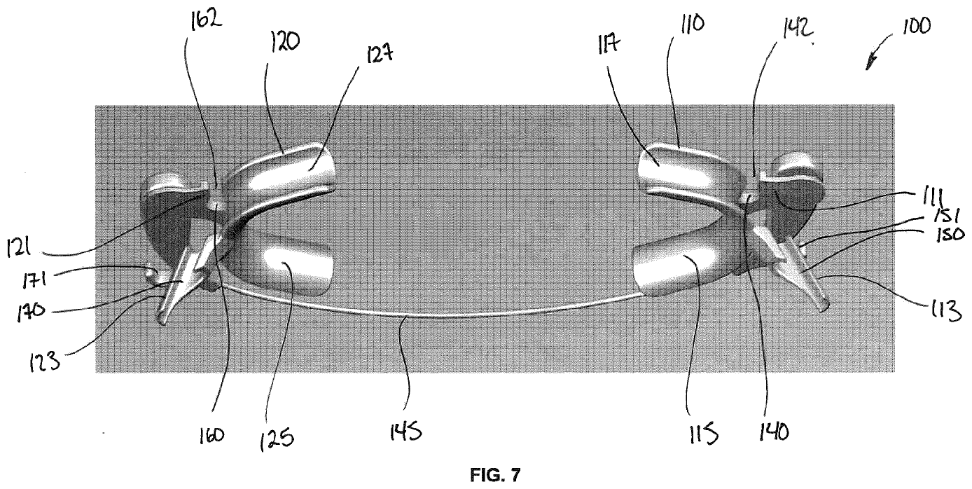

Referring to FIGS. 5-7, the external member 100 can include a first lip retractor 110, a second lip retractor 120, a first retractor flange 111, a second retractor flange 121, a first wing member 113, a second wing member 123, and, a flexible resilient member 145.

The first and second lip retractors 110, 120 can be used to hold the patient's lips open and can each have a generally, arcuate shape with an inner surface 115, 125 and an outer surface 117, 127, respectively. The outer surfaces 117, 127 can have an open channel with a substantially semi-circular cross-section so that a patients lips will come into contact with this outer surface 117, 127 and the lips will be held in place on the lip retractors 110, 120 within the semi-circular channels.

The first retractor flange 111 can be connected to the first lip retractor 110 at a front end of the first lip retractor 110 and extending outwards from the outer surface 117, 127 of the first lip retractor 110. The second retractor flange 121 can be connected to the second lip retractor 120 at a front end of the second lip retractor 120 and extending outwards from the outer surface 117, 127 of the second lip retractor 120.

The first wing member 113 can be attached to the first lip retractor 110 extending backwards into the mouth of the patient and angled outwards when the external member 100 is positioned holding open a patient's lips. The inner surface of the first wing member 113 can align with the inner surface 115 of the first lip retractor 110 where the first wing member 113 connects with the first lip retractor 110.

The second wing member 123 can be attached to the second lip retractor 120 extending backwards into the mouth of the patient and angled outwards when the external member 100 is positioned holding open a patient's mouth. The inner surface of the second wing member 123 can align with the inner surface 125 of the second lip retractor 120 where the second wing member 123 connects with the second lip retractor 120.

The first wing member 113 and the second wing member 123 can press against the inner cheeks of a patient when the external member 100 is inserted in the patient's mouth to keep the cheeks of the patient out of the way.

The flexible resilient member 145 can be connected between the first retractor flange 111 and the second retractor flange 121 and can act as a biasing member to spread the first retractor flange 111 and the second retractor flange 121 apart and therefore the first lip retractor 110 and the second lip retractor 120 apart from one another.

The lip retractors 110, 120 can have provisions for the first suction arm 20 and the second suction arm 40 to be connected behind the outer surfaces 117, 127, so that the connected suction arms 20, 40 will pass into a patient's mouth between the patient's oral commissure and the outer surfaces 117, 127 of the lip retractors 110, 120.

The suction arms 20, 40 can be connected to the lip retractors 110, 120 through first and second apertures 140, 160 passing through the retractor flanges 111, 121, respectively. A first channel 150 can be provided in the first wing member 113 and aligned with the first aperture 140 so that tubing inserted in the first aperture 140 can be positioned in this first channel 150 as well. A second channel 170 can be provided in the second wing member 123 and aligned with the second aperture 160 so that tubing inserted in the second aperture 160 can be positioned in this second channel 170 as well. In one aspect, the first and second apertures 140, 160 can have first and second openings 142, 162 on an edge at a top of the first and second retractor flanges 111, 121, respectively. The first opening 142 can lead into the first aperture 140 and the second opening 162 can lead into the second aperture 160.

This can allow the suction arms 20, 40 to be inserted through the openings 142, 162 into the apertures 140, 160 to be held in place in the retractor flanges 111, 121. This can also allow the suction arms 20, 40 to be removed from the apertures 140, 160 and the length they are inserted in a patient's mouth to be adjusted before being inserted back into the apertures 140, 160, without having to remove the suction arms 20, 40 from the patient's mouth.

The channels 150, 170 can be generally c-shaped and sized to allow the suction arms 20, 40 to be inserted in the channels 150, 170. The channels 150, 170 can each have a length so that a length of one of the suction arms 20, 40 can be supported in the channels 150, 170

An outer wall 152 of the channel 150 can extend further than an inner wall 154 of the channel 150 to define a cutout in a rear of the channel 150. The longer outer wall 152 can still allow the first retractor wing 113 to still press a patient's cheek outwards, while the shorter inner wall 154 can allow the first or second suction arm 20, 40 to be bent inwards without affecting the positioning of the first retractor wing 113.

An outer wall 172 of the channel 170 can extend further than an inner wall 174 of the channel 170 to define a cutout in the channel 170. The longer outer wall 172 can still allow the second retractor wing 123 to still press a patient's cheek outwards, while the shorter inner wall 174 can allow the first or second suction arm 20, 40 to be bent inwards without affecting the positioning of the second retractor wing 123.

A first clip 151 and a second clip 171 can be provided to connect to either the first suction arm 20 or the second suction tip 40 so that the suction arms 20, 40 can be clipped in and out of the way when a dental procedure is being performed on a patient.

In operation, the dental appliance 10 can be used to create a dry field in a patient's mouth by removing fluid and other materials from the patient's mouth. The external member 100 can be inserted into the patient's mouth to spread their lips and cheeks open and the first and second suction arms 20, 40 can be inserted into the patient's mouth to where fluid and debris is pooling to suck out the fluid and debris.

The external member 100 can be used to hold open a patient's mouth. The user can squeeze the first lip retractor 110 and the second lip retractor 120 towards one another, overcoming the biasing forced provided by the flexible resilient member 145 biasing the first lip retractor 110 and the second lip retractor 120 outwards, so that the lip retractors 110, 120 and the wing member 113, 123 can be inserted into the patient's mouth with the wing member 113, 123 and the rear ends of the lip retractors 110, 120 inside the patient's mouth until the channels in the outer surfaces 117, 127 of the lip retractors 110, 120 line up with the lips of the patient. The retractor flanges 111, 121 and the flexible, resilient member 145 will remain outside the patient's mouth and in front of their cheeks and chin.

The user can then slowly stop squeezing the lip retractors 110, 120 towards one another, allowing the biasing force of the resilient member 145 to once against spread apart the first lip retractor 110 and the second lip retractor 120 until the outer surfaces 117, 127 of the lip retractors 110, 120 come in contact with the patient's lips and then lightly force the patient's lips outwards.

The first wing member 113 and the second wing member 123 can press against the inner cheeks of a patient for force the patient's cheeks outward and out of the way.

With the external member 100 positioned holding open the mouth of the patient, the first suction arm 20 and the second suction arm 40 can be positioned in the patient's mouth.

The first and second suction arms 20, 40 can be inserted into the patient's mouth and held at a desired length, extending into the patient's mouth, relative to the external member 100. To secure the first and second suction arms 20, 40 to the external member, the first suction arm 20 can be inserted into the first aperture 140 passing through the first retractor flange 111 and the second suction arm 40 can be inserted into the second aperture 160 passing through the second retractor flange 121. The first suction arm 20 can then be inserted into the first channel 150 provided on the first retractor wing 113 and the second suction arm 40 can then be inserted into the second channel 170 provided on the second retractor wing 123.

In some cases, it may be desirable for the user to only insert use one of the two suction arms 20, 40 because both suction arms may not be needed for moisture control.

When the external member 100 is position in a patient's mouth with the lip retractors 110, 120 spreading open the patient's lips and the suction arms 20, 40 positioned in the first and second apertures 140, 160 and the first and second channels 150, 170, respectively, the first suction arm 20 will pass through the opening formed between the patient's oral commissure and the outer surface 117 of the lip retractor 110 and the second suction arm 40 will pass through the opening formed between the patient's oral commissure and the outer surface 127 of the lip retractor 120. In this manner, the suction arms 20, 40 will not run in between the inner surface 115 of the lip retractor 110 and the inner surface 125 of the lip retractor 120, freeing up space for the dentist, hygienist, etc. to work in the patient's mouth.

The suction arms 20, 40 can be bent and posed so that the second ends 34, 54 of the suction arms 20, 40 with their suction tips 26, 46 can be directed to where moisture and/or debris is building up in the patient's mouth. Because of the poseability of the suction arms 20, 40, the suction arms 20, 40 will remain in the position placed by the user until the user bends and poses them in a new position.

The shorter inner walls 154, 174 of the channels 150, 170 can allow the first and second suction arms 20, 40 to be bend inward, inside the patient's mouth, and have less effect on the position of the first and second wing retractors 113, 123.

The first ends 32, 52 of the first and second suction arms 20, 40 can be connected to a vacuum source (not shown), by the connector 36, so that fluid and other debris can be suctioned through the suction tips 26, 46 on the second ends 34, 54 of the suction arms 20, 40, into and up through the tubing 22, 42 of the suction arms 20, 40 to create a dry field in the patient's mouth.

Once the dental appliance 10 is done being used and removed from the patient's mouth, the suction arms 20, 40 and the external member 100 can be separated. The suction arms 20, 40 can be disposed of, such as if it cannot be safely or sufficiently sterilized, and the external member 100 can be reused, if it can be sufficiently sterilized.

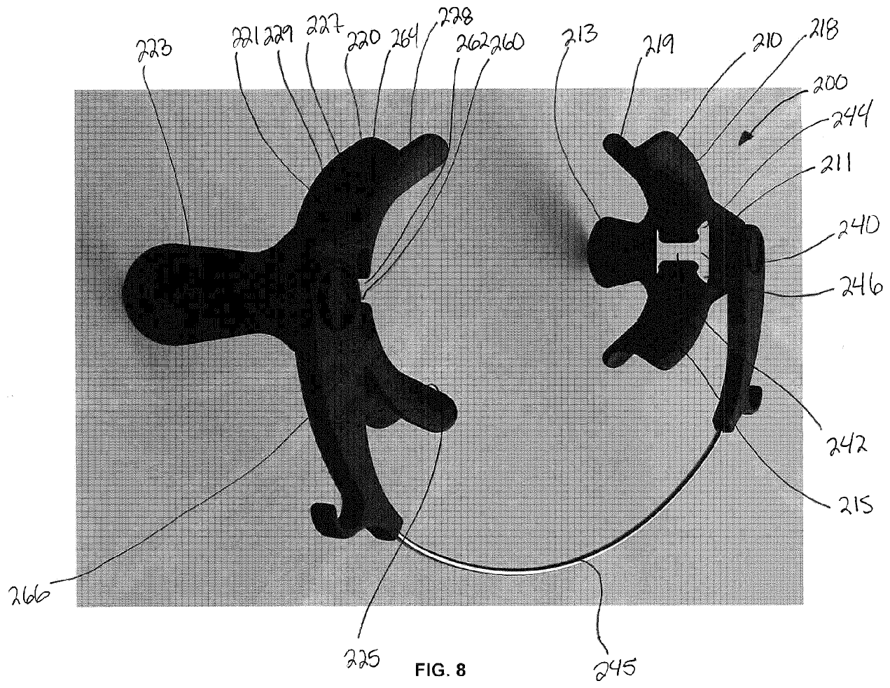

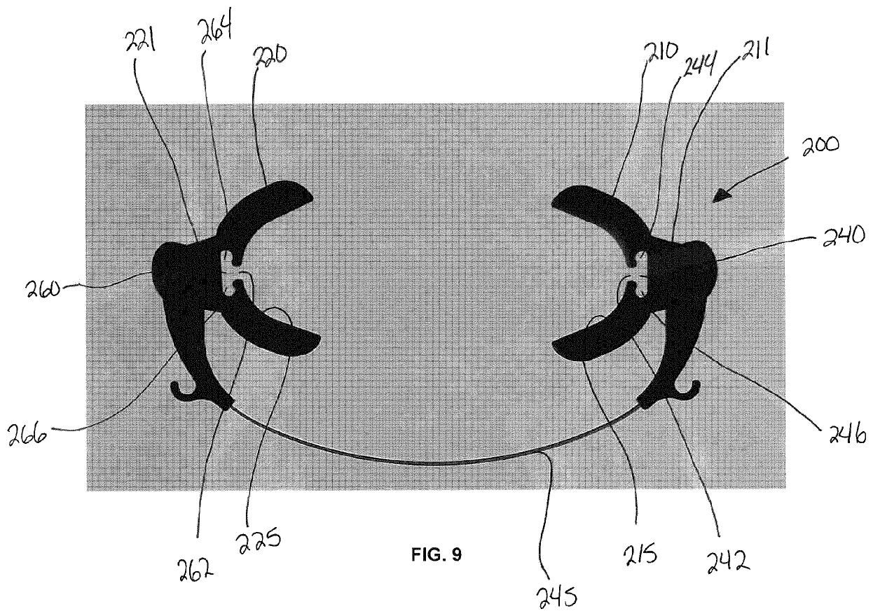

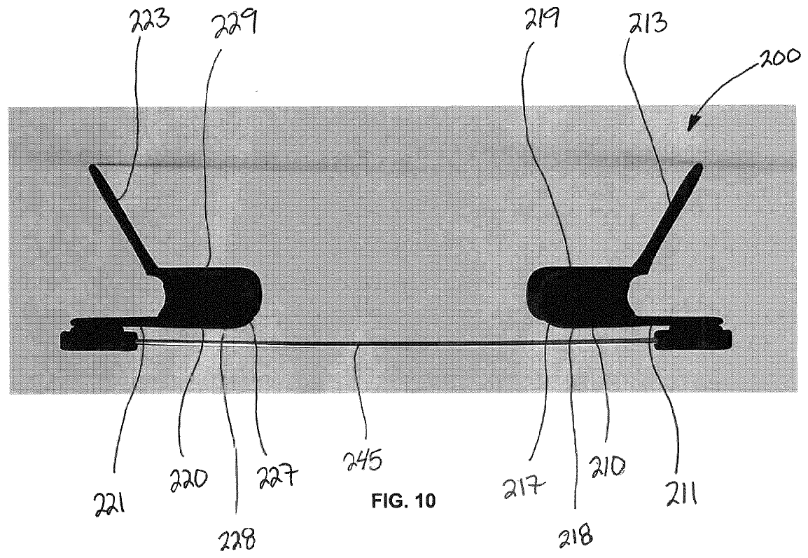

Referring to FIGS. 8-10, an external member 200 in a further aspect is shown. The external member 200 can include a first lip retractor 210, a second lip retractor 220, a first retractor flange 211, a second retractor flange 221, a first wing member 213, a second wing member 223, and, a flexible resilient member 245.

The first and second lip retractors 210, 220 can be used to hold the patient's lips open and can each have a generally, arcuate shape with an inner surface 215, 225 and an outer surface 217, 227, respectively. The outer surfaces 217, 227 can have an open channel with a substantially semi-circular cross-section forming front walls 218, 228 that will face outwards from a patient's mouth and back walls 219, 229 that will face inwards into the patient mouth, when the external member 200 is positioned in the mouth of a patient. A patient's lips will come into contact with this outer surface 217, 227 and the lips will be held in place on the lip retractors 210, 220 within the semi-circular channels.

The first retractor flange 211 can be connected to the first lip retractor 210 at a front end of the first lip retractor 210 and extending outwards from the outer surface 217, 227 of the first lip retractor 210. The second retractor flange 221 can be connected to the second lip retractor 220 at a front end of the second lip retractor 220 and extending outwards from the outer surface 217, 227 of the second lip retractor 220.

The first wing member 213 can be attached to the first lip retractor 210 extending backwards into the mouth of the patient and angled outwards when the external member 200 is positioned holding open a patient's lips.

The second wing member 223 can be attached to the second lip retractor 220 extending backwards into the mouth of the patient and angled outwards when the external member 200 is positioned holding open a patient's mouth.

The first wing member 213 and the second wing member 223 can press against the inner cheeks of a patient when the external member 200 is inserted in the patient's mouth to keep the cheeks of the patient out of the way.

The flexible resilient member 245 can be connected between the first retractor flange 211 and the second retractor flange 221 and can act as a biasing member to spread the first retractor flange 211 and the second retractor flange 221 apart and therefore the first lip retractor 210 and the second lip retractor 220 apart from one another.

The first lip retractor 210 can have a first aperture 240 passing through it and the second lip retractor 220 can have a second aperture 260 passing through it. The first aperture 240 and second aperture 260 can be sized to accept tubing, such as the first suction arm 20 or the second suction arm 40, or tubing connected to a traditional tongue crib.

The first aperture 240 can pass through both the front wall 218 and the back wall 219 of the first lip retractor 210 and the second aperture 260 can pass through both the front wall 228 and the back wall 229 of the second lip retractor 220.

A first opening 242 can be provided in the inner surface 215 of the first lip retractor 210 and leading into the first aperture 240. The first opening 242 can be sized to allow tubing, such as the first suction arm 20 of the second suction arm 40 to pass through the first opening 242 and into the first aperture 240.

A second opening 262 can be provided in the inner surface 225 of the second lip retractor 220 and leading into the second aperture 260. The second opening 262 can be sized to allow tubing, such as the first suction arm 20 of the second suction arm 40 to pass through the second opening 262 and into the second aperture 260.

In this manner, tubing, such as the suction arms 20, 40 can be inserted into a patient's mouth in between the first lip retractor 210 and the second lip retractor 220 that are holding the patient's lips apart and mouth open. Then, without having to remove the external member 220 from the patient's mouth, the first suction arm 20 can be inserted through the first opening 242 and into the first aperture 240 to be held in place in the first aperture 240 and the second suction arm 40 can be inserted through the second opening 262 and into the second aperture 260 to be held in place in the second aperture 260. If it is desirable to move the first and or second suction arm 20, 40 and reposition them in the patient's mouth, the first suction arm 20 can be removed from the first aperture 240 through the first opening 242 and repositioned before being inserted back through the first opening 242 to be secured in the first aperture 240 and the second suction arm 40 can be removed from the second aperture 260 through the second opening 262 and repositioned before being inserted back through the second opening 262 to be secured in the second aperture 260 again. This can all be done without having to remove the external member 220 from the patient's mouth because of the position of the first opening 242 and the second opening 262 in the in inner surface 215 of the first lip retractor 210 and the inner surface 225 of the second lip retractor 220, respectively.

In one aspect, the first aperture 240 can have an upper portion 244 and a lower portion 246, with the upper portion 244 of the first aperture 240 extending above the first opening 242 and the lower portion 246 of the first aperture 240 extending below the first opening 242. The upper portion 244 can be sized to pressure fit tubing, securing the tubing in the upper portion 244, and the lower portion 246 can be sized to pressure fit tubing, securing the tubing in the lower portion 246, so that a user can insert tubing, such as the first suction arm 20 through the first opening 242 and then move the tubing upwards to secure it in the upper portion 244 of the first aperture 240 or move it downwards to secure it in the lower portion 246 of the first aperture 240.

The second aperture 260 can have an upper portion 264 and a lower portion 266, with the upper portion 264 of the second aperture 260 extending above the second opening 262 and the lower portion 266 of the second aperture 260 extending below the second opening 262. The upper portion 264 can be sized to pressure fit tubing and the lower portion 266 can be sized to pressure fit tubing so that a user can insert tubing, such as the second suction arm 40 through the second opening 262 and the move the tubing upwards to secure it in the upper portion 264 of the second aperture 260 or move it downwards to secure it in the lower portion 266 of the second aperture 260.

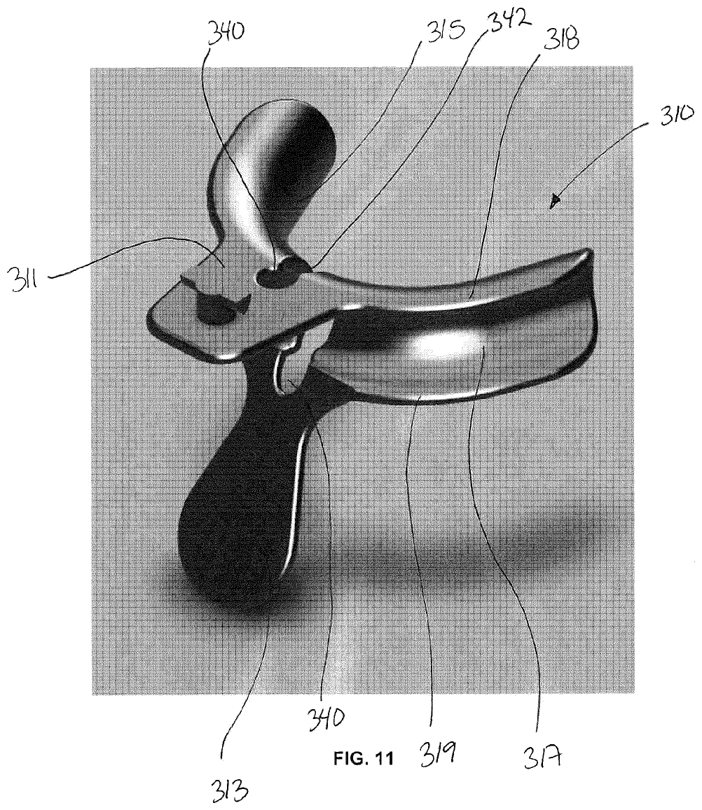

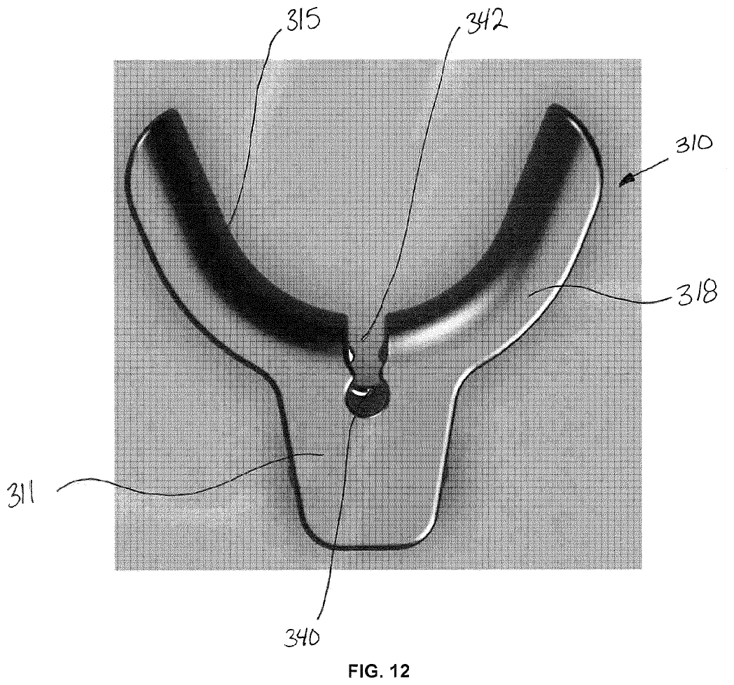

FIGS. 11 and 12 illustrates a lip retractor 310 in a further aspect. The lip retractor 310 can be connected to a retractor flange 311, with the retractor flange 311 extending outwards from the lip retractor 310. The retractor flange 311 can be connected to a flexible resilient member (not shown) that can be connected on the other side to a lip retractor that can be a mirror image of the lip retractor 310 to form an external member.

The lip retractor 310 can be used to hold the patient's lips open and can have a generally, arcuate shape with an inner surface 315 and an outer surface 317. The outer surface 317 can have an open channel with a substantially semi-circular cross-section forming a front wall 318 that will face outwards from a patient's mouth and a back wall 319 that will face inwards into the patient mouth, when the lip retractor 310 is positioned in the mouth of a patient. A patients lips will come into contact with this outer surface 317 and the lips will be held in place on the lip retractors 310 within the semi-circular channels.

A wing member 313 can be attached to the lip retractor 310 extending backwards into the mouth of the patient and angled outwards when the lip retractor 310 is positioned holding open a patient's lips.

An aperture 340 can pass through the lip retractor 310 and/or the reactor flange 311 and the wing member 313. Depending on the positioning of the aperture 340, all of the aperture 340 can pass through both the front wall 318 and the back wall 319 on the lip retractor 310. Alternatively, as shown in FIGS. 11 and 12, a portion of the aperture 340 can pass through both the front wall 318 and the back wall 319 on the lip retractor 310 with the other portion of the aperture 340 passing through the retractor flange 311 and the wing member 313. In a further aspect, the aperture 340 may be positioned so that all of the aperture 340 can pass through the retractor flange 311 and/or all of the aperture can pass through the wing member 313.

The aperture 340 can be sized to accept tubing, such as the first suction arm 20 or the second suction arm 40, or tubing connected to a traditional tongue crib. The aperture 340 can be sized the tubing to be pressure fit in the aperture 340 holding the tubing in place in the aperture 340.

An opening 342 can be provided in the inner surface 315 of the lip retractor 310 and leading into the aperture 340. The opening 342 can be sized to allow tubing, such as the first suction arm 20 of the second suction arm 40 to pass through the first opening 242 and into the first aperture 240.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. An intra-oral dental appliance comprising:
an external member;
a flexible and poseable first suction arm comprising: a first end; a second end, hollow tubing; and a suction tip provided at the second end of the first suction arm;
a flexible and poseable second suction arm comprising: a first end; a second end;
hollow tubing; a poseable wire integrated into the tubing; and a suction tip provided at the second end of the second suction arm; and
a connector connected to the first end of the first suction arm and the first end of the second suction arm, the connector connectable to a vacuum source,
wherein the second end of the first suction arm is positionable independently from the second end of the second suction arm,
and wherein the first suction arm and the second suction arm connectable to the external member.

2. The intra-oral dental appliance of claim 1 further comprising: a first poseable wire integrated into the tubing of the first suction arm; and, a second poseable wire integrated into the tubing of the second suction arm.

3. The intra-oral dental appliance of claim 1 wherein the suction tip provided on the second end of the first suction arm comprises at least one aperture, the at least one apertures smaller than the cross-sectional area of the tubing of the first suction arm.

4. The intra-oral dental appliance of claim 1 wherein the external member comprises:
a first lip retractor having a generally arcuate shape with an inner surface and an outer surface having an open channel with a substantially semi-circular cross-section;
a second lip retractor having a generally arcuate shape with an inner surface and an outer surface having an open channel with a substantially semi-circular cross-section;
a first retractor flange having a front end connected to the first lip retractor and extending outwards from the other surface of the first lip retractor;
a second retractor flange having a front end connected to the second lip retractor and extending outwards from the other surface of the second lip retractor;
a first wing member attached to the first lip retractor and extending backwards from the inner surface of the first lip retractor;
a second wing member attached to the second lip retractor and extending backwards from the inner surface of the second lip retractor; and
a flexible resilient member connected between the first retractor flange and the second retractor flange, the flexible resilient member biasing the first lip retractor and the second lip retractor apart.

5. An external member for keeping a patient's mouth open, the external member comprising:
a first lip retractor having a generally arcuate shape with an inner surface and an outer surface having an open channel with a substantially semi-circular cross-section;
a second lip retractor having a generally arcuate shape with an inner surface and an outer surface having an open channel with a substantially semi-circular cross-section;
a first retractor flange having a front end connected to the first lip retractor and extending outwards from the other surface of the first lip retractor;
a second retractor flange having a front end connected to the second lip retractor and extending outwards from the other surface of the second lip retractor;
a first wing member attached to the first lip retractor and extending backwards from the inner surface of the first lip retractor;
a second wing member attached to the second lip retractor and extending backwards from the inner surface of the second lip retractor;
a flexible resilient member connected between the first retractor flange and the second retractor flange, the flexible resilient member biasing the first lip retractor and the second lip retractor apart;
a first aperture sized to accept tubing and passing through the first retractor flange;
a first opening at a top of the first retractor flange and leading into the first aperture;
a second aperture sized to accept tubing and passing through the second retractor flange;
a second opening at a top of the first retractor flange and leading into the second aperture;
a first channel provided in the first wing member and aligned with the first aperture, the first channel having an outer wall and an inner wall, the outer wall of the first channel extending further than the inner wall of the first channel; and
a second channel provided in the second wing member and aligned with the second aperture, the second channel having an outer wall and an inner wall, the outer wall of the second channel extending further than the inner wall of the second channel.

6. An external member for keeping a patient's mouth open, the external member comprising:
a first lip retractor having a generally arcuate shape with an inner surface and an outer surface having an open channel with a substantially semi-circular cross-section;
a second lip retractor having a generally arcuate shape with an inner surface and an outer surface having an open channel with a substantially semi-circular cross-section;
a first retractor flange having a front end connected to the first lip retractor and extending outwards from the other surface of the first lip retractor;
a second retractor flange having a front end connected to the second lip retractor and extending outwards from the other surface of the second lip retractor;
a first wing member attached to the first lip retractor and extending backwards from the inner surface of the first lip retractor;
a second wing member attached to the second lip retractor and extending backwards from the inner surface of the second lip retractor;
a flexible resilient member connected between the first retractor flange and the second retractor flange, the flexible resilient member biasing the first lip retractor and the second lip retractor apart;
a first aperture sized to accept tubing and passing through at least one of: the first lip retractor; and, the first retractor flange;
a first opening in the inner surface of the of the first lip retractor sized to allow tubing to pass through the first opening, the first opening leading into the first aperture;
a second aperture sized to accept tubing and passing through at least one of: the second lip retractor; and, the second retractor flange; and
a second opening in the inner surface of the of the second lip retractor sized to allow tubing to pass through the second opening, the second opening leading into the second aperture.

7. The external member of claim 6 wherein the first lip retractor further comprises: a front wall; and, a back wall, and the second lip retractor further comprises: a front wall; and, a back wall, and wherein the first aperture passes through both the front wall and the back wall of the first lip retractor and the second aperture passes through both the front wall and the back wall of the second lip retractor.

8. The external member of claim 7 wherein a portion of the first aperture passes through the front wall of the first lip retractor and an other portion of first aperture passes through the first retractor flange.

9. The external member of claim 7 wherein a portion of the first aperture passes through the back wall of the first lip retractor and an other portion of first aperture passes through the first wing member.

10. The external member of claim 6 wherein the first aperture passes through first retractor flange and the first aperture passes through the first wing member.

11. The external member of claim 6 wherein the first aperture has an upper portion extending above the first opening and a lower portion extending below the first opening.

12. The external member of claim 11 wherein the upper portion is sized to pressure fit tubing in the upper portion and the lower portion is sized to pressure fit tubing in the lower portion.
